(19) United States
(12) Patent Application Publication
(10) Pub. No.: US 2014/0354570 A1
(43) Pub. Date: Dec. 4, 2014

(54) HAPTIC COMPANION DEVICE

(71) Applicant: Senseg Ltd., Espoo (FI)

(72) Inventors: Ville Makinen, Espoo (FI); Jukka Linjama, Espoo (FI); Zohaib Gulzar, Helsinki (FI)

(73) Assignee: Senseg Ltd., Espoo (FI)

(21) Appl. No.: 14/293,777

(22) Filed: Jun. 2, 2014

Related U.S. Application Data
(60) Provisional application No. 61/830,079, filed on Jun. 1, 2013.
(60) Provisional application No. 61/940,587, filed on Feb. 17, 2014.

(51) Int. Cl. G06F 3/041; G06F 3/0481; G06F 3/0488

(52) U.S. Cl. CPC G06F 3/041; G06F 3/0488; G06F 3/04817
USPC 345/173

(57) ABSTRACT

A haptic companion device may take the example form of a haptic cover that includes a housing and a transparent component. The housing may be shaped and dimensioned to receive a host device that includes a touch screen, and the touch screen may be configured to sense an input by a body member of a user of the host device. The transparent component overlays the touch screen of the host device when the haptic companion device is in use, and graphical objects displayed on the touch screen of the host device are visible through the transparent component. The haptic companion device includes a communication interface configured to communicatively couple the haptic companion device with the host device. The haptic companion device also includes electronic circuitry coupled to the transparent component. The electronic circuitry is configured to provide a haptic effect to the body member via the transparent component.

### RELATED APPLICATIONS

This application claims the priority benefit of U.S. Provisional Patent Application No. 61/830,079 (Attorney Docket No. 3187.005PV2)), filed Jun. 1, 2013, and U.S. Provisional Patent Application No. 61/940,587 (Attorney Docket No. 3187.019PRV)), filed Feb. 17, 2014, all of which are incorporated herein by reference in their entirety.

### TECHNICAL FIELD

The subject matter disclosed herein generally relates to electronic devices. Specifically, the present disclosure addresses a haptic companion device.

### BACKGROUND

Devices (e.g., electronic devices) are available in a wide range of sizes, shapes, and styles. For example, a device of a user (e.g., a user device) may take the form of a desktop computer (e.g., a personal computer (PC) or a deskside computer), a vehicle computer (e.g., fully or partially incorporated into a car, bus, boat, or airplane), a tablet computer, a navigational device (e.g., a global positioning system (GPS) device), a portable media device, a smartphone, a wearable device (e.g., a smart watch or smart glasses), or any suitable combination thereof. Moreover, a device may be configured (e.g., by suitable, hardware, suitable software, or both) to interact with one or more additional devices. As an example, the device may include one or more hardware communication interfaces (e.g., for wired or wireless communication), and the device may be configured (e.g., by hardware, software, or both) to support one or more communication protocols that enable the device to use a hardware communication interface to communicate with one or more other devices.

### BRIEF DESCRIPTION OF THE DRAWINGS

Some embodiments are illustrated by way of example and not limitation in the figures of the accompanying drawings.

FIG. 1 is a perspective view of a haptic companion device that covers at least two edges of a host device, according to some example embodiments.

FIG. 2 is a perspective view of a haptic companion device that covers one or more parts of a host device, according to some example embodiments.

FIG. 3 is a side elevation view of a haptic companion device that covers a curved surface of a host device, according to some example embodiments.

FIG. 4 is a side elevation view of a haptic companion device that covers a flat surface of a host device, according to some example embodiments.

FIG. 5 is a face view of a back surface of a haptic companion device in the example form of a haptic cover, according some to example embodiments.

FIG. 6 is a perspective view of a host device incorporated into a haptic companion device in the example form of a haptic cover, according to some example embodiments.

FIG. 7 is a face view of a front screen of a haptic companion device in the example form of a haptic cover with a Senseg Tixel® layer, according to some example embodiments.

FIG. 8 is an exploded view of a Senseg Tixel® layer, according to some example embodiments.

FIG. 9 is a perspective view of a haptic companion device in the example form of a haptic cover, according to some example embodiments.

FIG. 10 is a face view of a back surface of a haptic companion device in the example form of a haptic cover, according to some example embodiments.

FIG. 11 is a schematic diagram illustrating components of a haptic companion device, according to some example embodiments.

FIG. 12 is an exploded view of a haptic companion device in the example form of a haptic cover, according to some example embodiments.

FIG. 13 is a top view of a housing of the haptic companion device, according to some example embodiments.

FIG. 14 is a conceptual diagram illustrating a haptic companion device, according to some example embodiments.

FIG. 15 is a conceptual diagram illustrating generation of a capacitive electrical coupling within a capacitive electrical interface (CEI), according to some example embodiments.

FIG. 16 is a perspective view of a haptic companion device, according to some example embodiments.

FIG. 17 is a cross-sectional view of the haptic companion device illustrated in FIG. 16, according to some example embodiments.

FIG. 18 is a block diagram illustrating components of the haptic companion device illustrated in FIGS. 16 and 17, according to some example embodiments.

FIG. 19 is a flowchart illustrating operations of a haptic companion device in performing a method of providing a haptic effect, according to some example embodiments.

FIG. 20 is a block diagram illustrating components of a machine (e.g., a device), according to some example embodiments, able to read instructions from a machine-readable medium and perform any one or more of the methodologies discussed herein.

### DETAILED DESCRIPTION

Example methods and systems are directed to a haptic companion device (e.g., a haptic cover). Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A haptic companion device may be an accessory for one or more other devices, including mobile and tablet devices. A haptic companion device may be used with another device, referred to herein as an “host device” (e.g., user device that hosts the haptic companion device). In various example embodiments, the haptic companion device may fully or partially cover the host device. Hence, the haptic companion device may be or include a “haptic cover” that engages with the host device and fully or partially covers the host device. For example, a haptic cover may be a functional cover (e.g., a case) that may be used with (e.g., added to) a host device (e.g., a mobile device). In some example embodiments, the host device has a touch screen interface, and the haptic cover may be added (e.g., attached) to the host device to fully or partially cover the touch screen interface of the host device.

The haptic cover may be configured (e.g., by suitable hardware, suitable software, or both) to provide one or more haptic effects (e.g., tactilely perceivable effects) to a user in response to one or more manipulation actions on the host device (e.g., on the touch screen of the host device), such as pressing a virtual key or an icon. In some example embodiments, the haptic cover may be attached to the host device and detached from the host device as desired by the user. The haptic cover may communicate with the host device to receive one or more signals usable to trigger one or more haptic effects. In some example embodiments, some software is installed on the host device (e.g., if sufficient software is not already installed on the host device) to enable the communication between the haptic cover and the host device.

In certain example embodiments, a haptic companion device is not directly attached to the host device (e.g., in the sense of actually covering up the host device) but is connected to the host device by a wired or wireless connection. In such example embodiments, the haptic companion device may nonetheless provide haptic effects to a user in response to manipulation actions on the haptic companion device. Hence, as used herein, the phrase “haptic companion device” refers to any kind of attachable or remotely connected extension to a host device (e.g., a mobile device) that provides haptic effects to the user of the host device.

Accordingly, a haptic companion device may be unattached to its host device. For example, such a haptic companion device may take the form of a wearable device (e.g., a smart watch, smart eyeglasses, a device that is integrated with clothing or jewelry, or any other device configured to be worn by its user). As another example, such a haptic companion device may simply be separately placed from its host device (e.g., communicatively coupled to the host device via wired or wireless communication), so that when any function is performed on the host device, the haptic companion device provides haptic feedback related to the action performed on the host device. In some example embodiments, a wearable haptic companion device is configured to provide one or more haptic effects continuously, periodically, intermittently, or any suitable combination thereof (e.g., by repeating a particular rhythm or pattern of haptic effects with some time gap between repetitions).

In some situations, the same user operates the host device (e.g., with one hand) while wearing the communicatively coupled haptic companion device (e.g., on a different hand, on a wrist, or on any other suitable part of the user's body). The user may execute one or more applications on the host device (e.g., playing a game), and the haptic companion device may provide haptic feedback in accordance with one or more actions performed by the user on the host device. According to some example embodiments, a single haptic companion device is configured or configurable to be either worn by the user or attached to the host device, according to the user's wishes. For example, such a haptic companion device may take the form of a bracelet that can be attached to the host device (e.g., attached or attachable to the back surface of the host device to provide haptic effects to a hand that is holding the host device). As another example, such a haptic companion device may take the form of a glove or mitten that doubles as a case for the host device. Haptic feedback may be provided by the exterior of the glove or mitten when the host device is inside the glove or mitten, and haptic feedback may be provided by the interior of the glove or mitten when the host device is detached and a user's hand is inside the glove or mitten.

In certain situations, the host device is used by a first user, while the remotely connected haptic companion device is used by a second user. For example, such a dual-user configuration may support a game in which the first user uses the host device to draw a shape on the host device, and the haptic companion device provides haptic effects that represent the drawn shape to the second user. The challenge of the game may be for the second user to guess the drawn shape based on this haptic feedback. The shape of the haptic companion device itself may be curved, flat, round, or any other suitable shape, which may make the game more challenging. In some example embodiments, the haptic companion device provides a second user with multiple choices (e.g., four shapes) choose from in guessing the drawn shape.

According to some example embodiments, a haptic companion device may have multiple host devices (e.g., several host devices). In such situations, either or both host devices may be communicatively coupled (e.g., via wired or wireless connections) to the haptic companion device to deliver haptic feedback. For example, a first person may be using a first host device with a haptic companion device (e.g., haptic cover) attached the first host device, while a second person to perform a particular task on a second host device that is communicatively coupled (e.g., via wired or wireless communication) to the first host device, to the haptic companion device, or to both. Accordingly, the performance of the particular task on the second host device may cause the haptic companion device to provide a haptic effect to the first person. For example, second host device may communicate directly with the haptic companion device attached the first host device and trigger the provision of the haptic effect by the haptic companion device. As another example, the second host device may communicate directly with the first host device (e.g., by application-to-application communication) to trigger the provision of a haptic effect.

The haptic effect triggered by the second host device may be or include a particular rhythm or pattern of haptic effects. However, in certain example embodiments, the second host device causes the haptic companion device to interrupt or disrupt a haptic effect (e.g., a specific rhythm or pattern of haptic effects) already being caused by the first host device. Such multiple host device configurations may be useful in a multi-player gaming applications (e.g., quiz games or fighting games), as well as in collaborative creative applications (e.g., art or music).

According to certain example embodiments, each of multiple host devices in communication with each other (e.g., via wired or wireless communications) may have a separate haptic companion device (e.g., attached or not attached). In some configurations, all of the host devices, haptic companion devices, or any suitable combination thereof, may be synced together to provide a single uniform haptic effect to each of their respective users. In alternative configurations, a specific haptic effect may be provided to only a subset of all the host devices, haptic companion devices, or any suitable combination thereof. For example, a specific haptic effect may be provided to only one user via only his haptic companion device, and the provision of the specific haptic effect may be triggered by information communicated to the user's host device one or more of the other host devices. In various example embodiments, a hardware toggle or dongle may be the basis upon which a specific haptic effect is selected or blocked for a particular subset of the multiple host devices.

For clarity, the discussion herein focuses on haptic covers. However, the methods and systems discussed herein apply to haptic companion devices in general. Haptic covers may take any of various forms of casings or attachments to host devices (e.g., mobile devices), such as cases, covers, skins, screen protectors, face plates, housings, armors, shields, stickers, sleeves, envelopes, or any suitable combination thereof. Accordingly, a haptic cover may provide decoration and protection for a host device, in addition to one or more haptic effects.

In some example embodiments, a haptic cover includes a back cover with specially configured electronics (e.g., Senseg Tixel® electronics) embedded therein and a front cover (e.g., a front tixel) with a specially configured tixel layer structure. The tixel layer structure may include a conductive (e.g., conducting) layer and at least one insulative (e.g., insulating) layer that separates the conductive layer from a user's finger touching the surface of the tixel layer structure. In certain example embodiments, the front cover takes the form of an attachable screen protector (e.g., a separate foil that can be overlaid on top of a touch screen of the host device). In various example embodiments, the front cover takes the form of a coating that is applied to the touch screen of the host device by a manufacturer of the host device (e.g., one or more coatings that form all or part of the tixel layer structure).

A haptic cover may be configured to offer haptic feedback to a user of the host device in various interaction situations. For example, the user can get a haptic confirmation when clicking an icon or a key shown on the touch screen of the host device and when typing on an on-screen keyboard (e.g., displayed on the touch screen). Also, a haptic effect can be given to help the user locate a button or any other interaction element shown on the touch screen.

Haptic feedback may be given when adjusting the volume of audio produced by the host device. The changing volume levels may be felt by the user's finger or hand as short, sharp haptic effects (e.g., tangible pulses), or the feeling may change in strength according to the direction of the change (e.g., providing a stronger feeling when the volume is increasing, and providing a weaker feeling when the volume is decreasing). Similar haptic feedback may also be given when the user is manipulating any virtual slider or wheel shown on the touch screen. Scrolling pages may be associated with a haptic effect. For example, when the user swipes a finger across the screen and a displayed page is scrolled according to the swipe, this interaction event may be indicated by a haptic event (e.g., a moving effect, a texture-like feeling, or a short click feeling). Also, dragging an object on the touch screen may have a similar haptic effect associated with it.

Zooming content displayed on the touch screen of the host device may be felt in a haptic cover (e.g., with a time-variant short effect, so that when zooming fast, haptic effects occur more often than when zooming slowly). For example, when the user chooses an option from a menu list (e.g., in a situation where the finger stays in contact with the touch screen), individual menu items may be felt as a sharp edge effect as the user's finger slides over and past each of them one by one.

The user may also receive a haptic feeling when touching links in a webpage displayed on the touch screen of the host device. For example, when the user moves his finger over (e.g., on top of) a link, a haptic effect (e.g., a short click) may be provided by the haptic cover. This may help the user in navigating the webpage. In addition, another haptic effect may be provided when the link is selected by the user. In some example embodiments, receiving a chat message may trigger a haptic effect from the haptic cover to the user. For example, when the user is in an instant message chat, an indication that a chat message from another participant is received may be felt as a haptic effect provided by the haptic cover.

In gaming, one or more haptic effects may significantly increase the realness of a game. Haptic effects via the haptic cover may be given when playing a game on the host device. Examples of such games include finger air hockey or flipper. The user may feel a bump provided by the haptic cover when he hits a disc or a ball in the game with his finger (e.g., as an indication of a collision).

Regarding form factors, some example embodiments of the haptic cover are implemented as an extension to a mobile device (e.g., as an accessory for a mobile device, handheld device, or other portable device). Other example embodiments of a haptic cover are integrated or integratable into the host device. Further example embodiments include a haptic cover that is an extension to a battery of the host device (e.g., a removable battery pack for the host device).

As noted above, a haptic companion device (e.g., haptic cover) may be attached to a host device and may be attached to at least part of the host device. For example, a haptic cover may encase the whole host device, part of the host device (e.g., the back, front, or one or more sides of the host device), or different sides of the host device (e.g., the back and front side). The host device may be fully or partially covered with multiple haptic covers (e.g., of different types) that are configured to work together. In certain example embodiments, a haptic cover includes multiple parts (e.g., two parts) where a first part is connected to the host device and sends a signal that causes a second part to trigger a haptic effect on a remote surface (e.g., on a second part). In some example embodiments, part of the haptic cover may be an additional component (e.g., an additional block) to the host device's battery (e.g., a removable battery pack).

FIGS. 1-4 illustrate some haptic companion devices in the example forms of haptic covers, according various example embodiments. FIG. 1 is a perspective view of a haptic cover that covers at least one edge of a host device, according to some example embodiments. The haptic cover may cover one or more edges of the host device (e.g., only one edge, exactly two edges, or all four edges of a rectangular host device). As shown in FIG. 1 by shaded areas, the haptic cover may cover a short edge 102 (e.g., a bottom edge or a side edge) and a long edge 104 (e.g., a side edge or a bottom edge) of the host device.

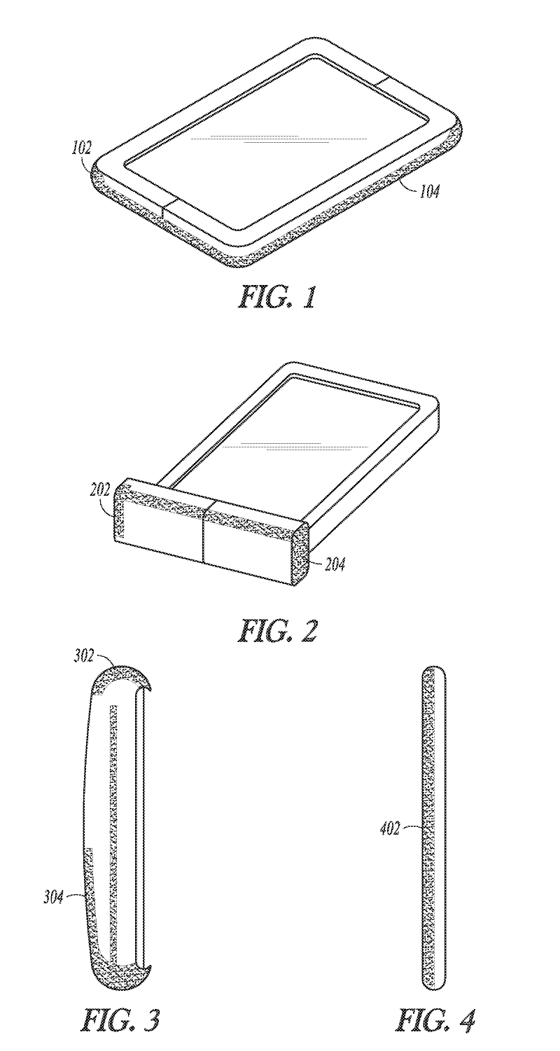

FIG. 2 is a perspective view of a haptic cover that covers one or more parts (e.g., components) of a host device, according to some example embodiments. The haptic cover may cover all or part of a detachable battery (e.g., a removable battery pack) that is attached to the host device. As shown in FIG. 2 by shaded areas, the haptic cover may cover a first zone 202 (e.g., a left region) and a second zone 204 (e.g., a right region) on a battery pack or other accessory attached to the host device.

FIG. 3 is a side elevation view of a haptic cover (e.g., a protective case) that covers one or more curved surfaces of a host device, according to some example embodiments. As shown in FIG. 3 by shaded areas, the haptic cover may cover a first zone 302 (e.g., a top region) of the host device, as well as a second zone 304 (e.g., a back-side-bottom region) of the host device.

FIG. 4 is a side elevation view of a haptic cover that covers one or more flat surfaces of a host device, according to some example embodiments. As shown in FIG. 4 by a shaded area, the haptic cover may take the form of a flat, thin touch screen protector 402 attached to the host device. As illustrated in FIGS. 3 and 4, a haptic cover may cover the entirety of the host device or a portion thereof. A haptic cover may cover a curved surface of the host device (e.g., as shown in FIG. 3), a flat surface of the host device (e.g., as shown in FIG. 4), or any suitable combination thereof. Accordingly, the shape of a haptic cover may be, for example, flat, curved, rectangular, contoured, or any suitable combination thereof. Moreover, one or more surfaces of the haptic cover may feel sticky, smooth, soft, hard, or any suitable combination thereof, to a user.

A haptic cover may be clipped on, glued on, or otherwise attached to the host device, according to various example embodiments. For example, the haptic cover may be a permanent attachment or may be removable whenever wanted. In some example embodiments, the haptic cover may be integrated into the host device. The haptic cover may include several parts (e.g., components), and different types of haptic covers may be communicatively connected to each other (e.g., as an arrangement of communicatively coupled haptic covers). As an example, the back of the host device may have one type of haptic cover (e.g., made with non-transparent material), and the front of the host device may have another type of haptic cover (e.g., transparent to prevent disturbing the view and usage of a touch screen interface of the host device).

In some example embodiments, multiple feelable areas (e.g., tactile pixels) may be integrated into one haptic cover and used to convey specific sensations to a touching body member (e.g., a user's finger or hand in contact with the haptic cover). Examples of such specific sensations include directional indicators (e.g., a haptic indication of a leftward direction or a rightward direction) and a moving touch contact (e.g., a sensation that something on the touch screen is moving beneath the user's finger). Such multiple feelable areas may be implemented using Senseg technology (e.g., Senseg Tixel® technology) to provide one or more haptic effects.

A wide variety of materials may be utilized to build a haptic cover. Suitable material may be flexible or rigid. In various example embodiments, the material is solid and moldable. Some examples of possible materials include materials that are metallic, alloy based, plastic, ceramic, semi-conductive, composite, wood, and any suitable combination thereof. Examples of suitable plastic materials include cellulose-based plastics, bakelite, polystyrene, polyvinyl chloride (PVC), nylon, rubber (e.g., natural or synthetic), and any suitable combination thereof. Examples of suitable semi-conductive materials include polymers (e.g., polyaniline), zinc oxides, carbon nanotubes, indium tin oxide (ITO), silicon, germanium, gallium arsenide, silicon carbide, and any suitable combination thereof.

A haptic effect in a haptic cover may be provided by any one or more of multiple methods, such as mechanical vibration motors (e.g., linear or rotary), piezo (e.g., piezoelectric) elements, attractive electrostatic force (e.g., Senseg Tixel®), electrostatic actuators, other mechanical actuators (e.g., active and passive), vibration created by oppositely charged plates, or any other technology that may be used to create the haptic effect. Any one or more of these technologies may be integrated into a haptic cover to provide a haptic effect. As a result, a user may feel one or more haptic effects when touching at least a part of a haptic cover.

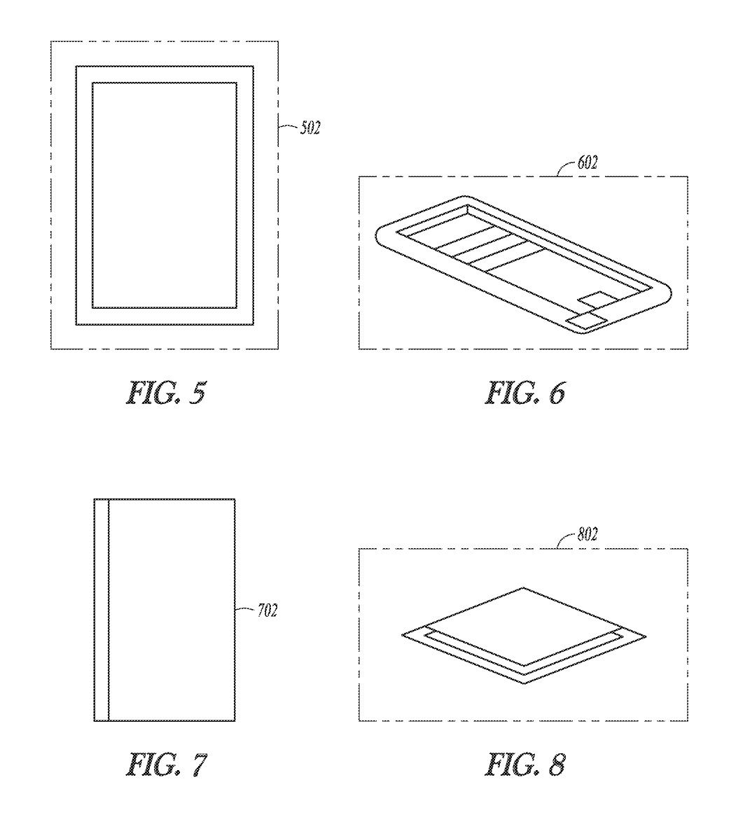

FIGS. 5-8 illustrate some example embodiments of integrating a haptic companion device with Senseg Tixel® technology. Specifically, FIG. 5 is a face view of a back surface of a haptic companion device in the example form of a haptic cover 502, according to some example embodiments. As shown in FIG. 5, the back surface may include a large central component (e.g., a tixel or other feelable area) configured to provide one or more haptic effects to a user. Such a back cover may be made of non-transparent materials.

Any one or more of the surfaces or edges of a haptic companion device (e.g., back surface, front surface, top edge, bottom edge, left edge, or right edge) may include one or more tixels (e.g., multi-layered tixel structures). For example, a multi-layer tixel structure may cover a back cover of a haptic companion device, or any portion thereof. In some example embodiments, one or more portions of such a back cover provide grounding for the multi-layered tixel structure. In situations where a multi-layered tixel structure covers a front surface of a haptic companion device (e.g., a front surface that, in use, overlays a touch screen of the corresponding host device) the multi-layered tixel structure may be transparent. In various example embodiments, a haptic companion device includes one or more tixels only on its back surface, only on its front surface, or on both front and back surfaces.

FIG. 6 is a perspective view of a host device 602 incorporated into a haptic companion device in the example form of a haptic cover (e.g., haptic cover 502), according to some example embodiments. As shown in FIG. 6, the host device may be incorporated (e.g., received) into the haptic cover (e.g., with a connector at a bottom end of the haptic cover).

FIG. 7 is a face view of a front screen 702 of the haptic cover a haptic cover (e.g., haptic cover 502), according to some example embodiments, and this front screen may include a Senseg Tixel® layer. In various example embodiments, multiple Senseg Tixel® layers may be included in the front screen 702 (e.g., covering different portions of the touch screen of the incorporated host device).

FIG. 8 is an exploded view of a Senseg Tixel® layer 802, according to some example embodiments, showing an insulator, a conductor (e.g., an electrode), and a substrate. According to various example embodiments, one or more Senseg Tixel® layers (e.g., layer 802) may be overlaid onto the touch screen of the host device.

As shown in FIGS. 5-8, the haptic cover may use Senseg Tixel® technology by Senseg to create one or more haptic effects. In FIGS. 5-8, a Senseg Tixel® layer is represented as a single uniform surface. Other example embodiments with Senseg Tixel® technology may have multiple Senseg Tixel® layers (e.g., as tixels) positioned separately but very close to each other (e.g., in a multi-tixel arrangement) within one haptic cover. With such an arrangement of multiple Senseg Tixel® layers, different haptic effects or differently timed haptic effects may be given to each tixel (e.g., to create a feeling of movement to the user).

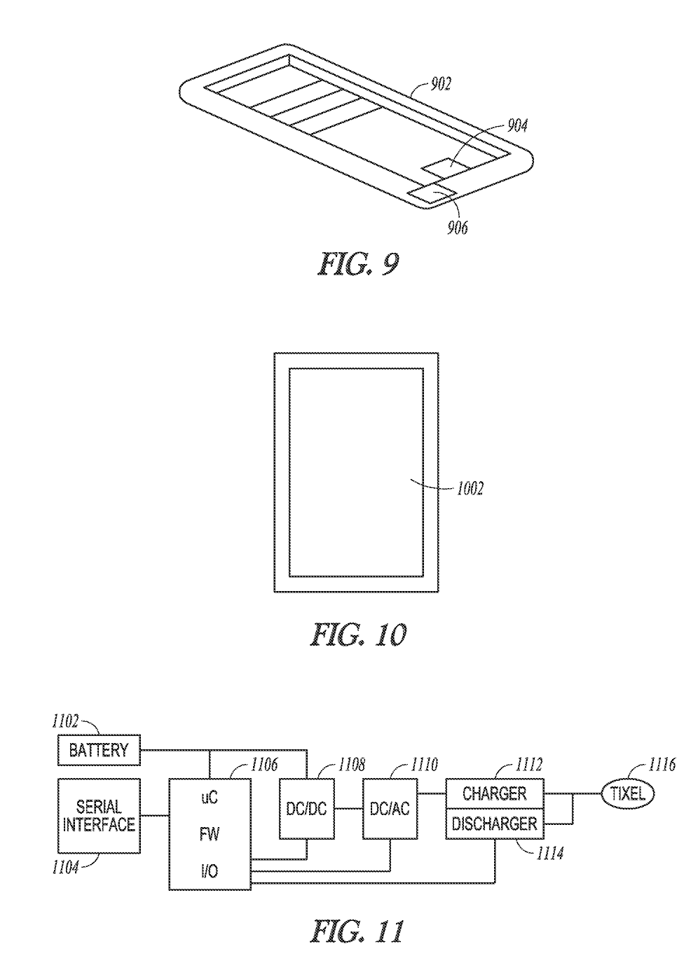

Additional example embodiments with different haptic feedback technology are presented in FIGS. 9 and 10. FIG. 9 is a perspective view of a haptic companion device in the example form of a haptic cover 902, according to some example embodiments. As shown in FIG. 9, the haptic cover 902 includes one or more vibration generators (e.g., “vibro motors”), one or more piezoelectric components (e.g., “piezo materials”), or any suitable combination thereof. The haptic cover 902 is shown as including a communication interface 904 (e.g., a physical connector) configured to establish communication between the host device and the haptic cover. In some example embodiments, the communication interface 904 is a wired interface. In alternative example embodiments, the communication interface 904 is a wireless interface. The haptic cover 902 may further include an additional communication interface 906 (e.g., a second physical connector) configured to establish communication with one or more external devices (e.g., personal computer or a battery charger), such that the host device, the haptic cover 902, or both, may communicate with such external devices.

FIG. 10 is a face view of a back surface of a haptic companion device in the example form of a haptic cover, according to some example embodiments. As shown in FIG. 10, since a hand of the user may frequently (e.g., primarily) touch the back surface of a haptic cover in use, the back surface of the haptic cover may include a large central component 1002 (e.g., a tixel or other feelable area) configured to provide one or more haptic effects to the user. For example, the large central component 1002 may include one or more vibration generators, one or more piezoelectric components, or any suitable combination thereof. Moreover, in certain example embodiments, one or more of such vibration generators or piezoelectric components may be incorporated into one or more edges of the haptic cover. Furthermore, in some example embodiments, such vibration generators or piezoelectric components may be arranged in multiple layers, which may create more sophisticated haptic effects for the user.

In various example embodiments of a haptic cover, an electronics module and a mechanics module (e.g., an assembly of one or more tixels) are both incorporated inside the haptic cover and connected to each other. The electronics module may include a communication interface (e.g., communication interface 904) configured to communicate with the host device via any kind of communication means, such as wireless (e.g., Wi-Fi or Bluetooth) networking or with a wired connection (e.g., a physical connector). The haptic cover itself may also have one or more connection methods (e.g., a wired or wireless connectors) to connect to any external device, such as PC or a battery charger. For getting power to operate, the haptic cover may have its own battery or it may use the battery of the host device (e.g., via a connector). Similarly, the haptic cover may be grounded (e.g., get its grounding) by using the host device's ground via a galvanic connection (e.g., in host devices that have a big ground, like Apple's iPad), or the haptic cover may have its own ground layer incorporated therein.

Regarding electronic components, various example embodiments of a haptic cover (e.g., a haptic cover using Senseg Tixel® technology) include a microcontroller (uC) (e.g., a processor), a memory, one or more peripheral controllers, an input/output (I/O) interface, and an electrostatic voltage driver. The microcontroller may be or include one or more processors (e.g., hardware processors). The memory may be or include flash memory (e.g., >8 kilobytes), static random access memory (SRAM) (e.g., >1 kilobyte), or any suitable combination thereof. Examples of peripheral controllers include timers, analog-to-digital converters (ADCs), universal asynchronous receivers/transmitters (UARTs), serial peripheral interface (SPI) bus controllers, inter-integrated circuit (I2C) bus controllers, or any suitable combination thereof. The I/O interface, according to some example embodiments, may have over 10 lines (e.g., digital lines).

FIG. 11 is a schematic diagram illustrating components of a haptic companion device, according to some example embodiments. In particular, FIG. 11 illustrates an electronics module of a haptic cover. As shown, the electronics module may include a battery 1102, the serial interface 1104, a controller 1106, a direct-current-to-direct-current (DC/DC) converter 1108, a direct-current-to-alternating-current (DC/AC) converter 1110, a charger 1112, and a discharger 1114. The charger 1112, the discharger 1114, or both, may be electrically and communicatively coupled to a tixel 1116 (e.g., a Senseg Tixel®. The haptic cover (e.g., via controller 1106) may incorporate firmware (labeled “FW” in FIG. 11) that supports one or more serial protocols and enables power-related functionality (e.g., DC operation, AC operation, battery charging, battery discharging, managed power-down, and a power-saving idle state). The haptic cover (e.g., via controller 1106) may support communication via one or more physical or wireless connections. Examples of supported communications include communications via serial interface, UART, SPI, universal serial bus (USB), 12C, male/female connectors (e.g., specific for each device), Bluetooth, Zigbee, infrared, ultra-wideband (UWB) radio technology, radio-frequency identification (RFID), near-field communications (NFC), Wi-Fi, or any suitable combination thereof.

An electrostatic voltage driver within the haptic cover may include the DC/DC converter 1108 (e.g., configured to convert a DC voltage from 3V to 300V or from 3V to 500V DC), the AC/DC converter (e.g., configured to convert an AC signal from 300V to 500V), or both. A voltage multiplier charger may be included in the electrostatic voltage driver, and the voltage multiplier charger may drive the output voltage from 300-500V to 3000-5000V. The electrostatic voltage driver may include the discharger 1114 (e.g., an active discharger) configured to discharge the output down to zero voltage.

A haptic cover may be configured by one or more pieces of software to provide the various functionalities described herein. For example, software may configure the haptic cover (e.g., via the microcontroller) to perform one or more of the following operations: receiving a signal about a meaningful event (e.g., a finger going over a link or edge) from the host device through a communication interface (e.g., a connector), and according to the received signal, outputting a haptic effect in the haptic cover. The haptic effect may either be chosen (e.g., selected) from a library of haptic effects or created on the spot. In some example embodiments, an operating system of the host device may be accessed by the software in order to generate or acquire meaningful event information for the providing of the haptic effect. In certain example embodiments, a haptic cover may be enabled to work with one or more software applications, such as games or communication applications (e.g., an instant messaging client).

Installation of the software may be done via a memory chip (e.g., integrated in the haptic cover) or via the Internet. A memory chip or card may be included in a haptic cover to provide general data storage (e.g., as external memory). Regarding Internet access to the software for a haptic cover, the software may be downloaded via one or more of various channels including websites, web stores to buy applications (e.g., an app store, an Android market, or an Ovi-portal), and other places where software can be purchased and downloaded. The software may also be directly delivered as an integrated part of the operating system of the host device (e.g., by an update to the operating system). In some example embodiments, the microcontroller of a haptic cover controller may receive touch input events directly from the host device (e.g., the touch screen of the host device, or any other component of the host device configured to detect or process user input).

The software that configures a haptic device may receive and manage one or more data flows and may control the haptic effects provided to the user. In some example embodiments, the software supports a protocol about the response time, so that a delay measured from an occurred event to an outputted haptic feedback is less than 20 ms.

In certain example embodiments, instead of accessing the operating system of the host device, a signal from the loudspeaker of the host device may be captured and used to trigger a haptic effect in response to certain meaningful sound-feedback events. A haptic cover may also support signal processing to convert any sound output from the host device (e.g., music or feedback signals). For example, one channel of audio content (e.g. a surround channel or a low frequency effect channel in a multi-channel audio format) may be converted to one or more tactile sensations. Alternatively, left and right stereo channels may be driven to left and right tixels (e.g., feel area parts) of a haptic cover (e.g., as described above with respect to FIGS. 1 and 2).

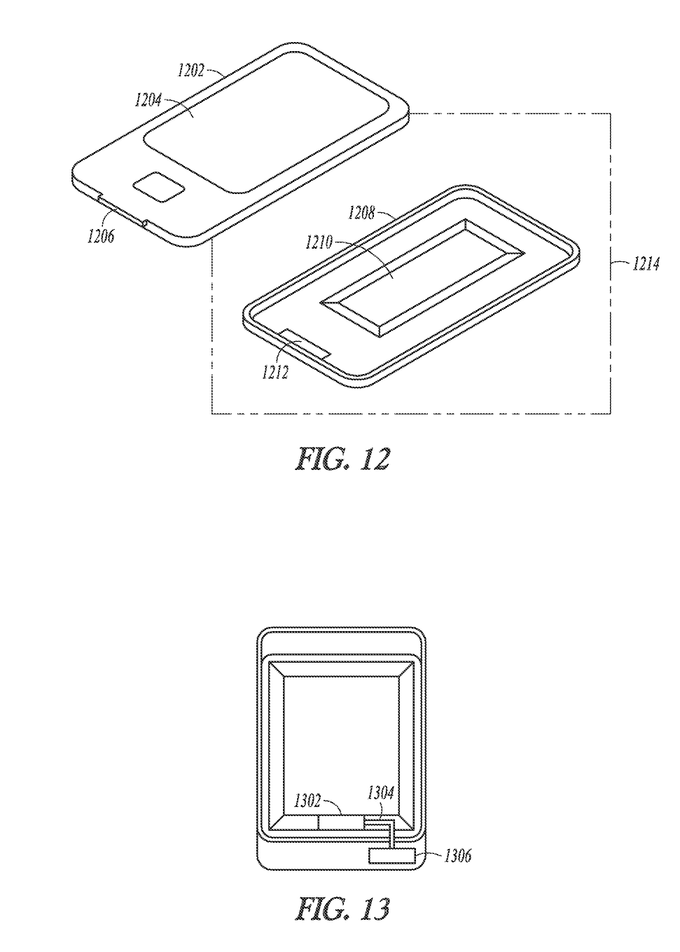

FIGS. 12-14 are conceptual diagrams illustrating a haptic cover 1214, according to some example embodiments. Specifically, FIG. 12 is an exploded view of the haptic cover 1214, according to some example embodiments, showing a host device 1202, a mechanics module 1204 (e.g., a transparent tixel implementing Senseg Tixel® technology), a host-side communication interface 1206 (e.g., physical connector or wireless interface), a housing 1208 (e.g., a back cover made of rubber or plastic), an electronics module 1210 (e.g., implementing Senseg Tixel® technology), and a communication interface 1212 (e.g., physical connector or wireless interface).

FIG. 13 is a top view of the housing 1208 of the haptic cover 1214, according to some example embodiments. As noted above with respect to FIG. 12, the housing 1208 includes the communication interface 1212. As shown in FIG. 13, according to certain example embodiments, the communication interface 1212 may be an internal communication interface 1302 (e.g., an internal connector) that is connected to an external communication interface 1306 by a connector 1304 (e.g., a wired or wireless connector). In some example embodiments, the external communication interface 1306 (e.g., an external connector) may enable the host-side communication interface 1206 of the host device 1212 to communicate with one or more external devices (e.g., a PC or a battery charger).

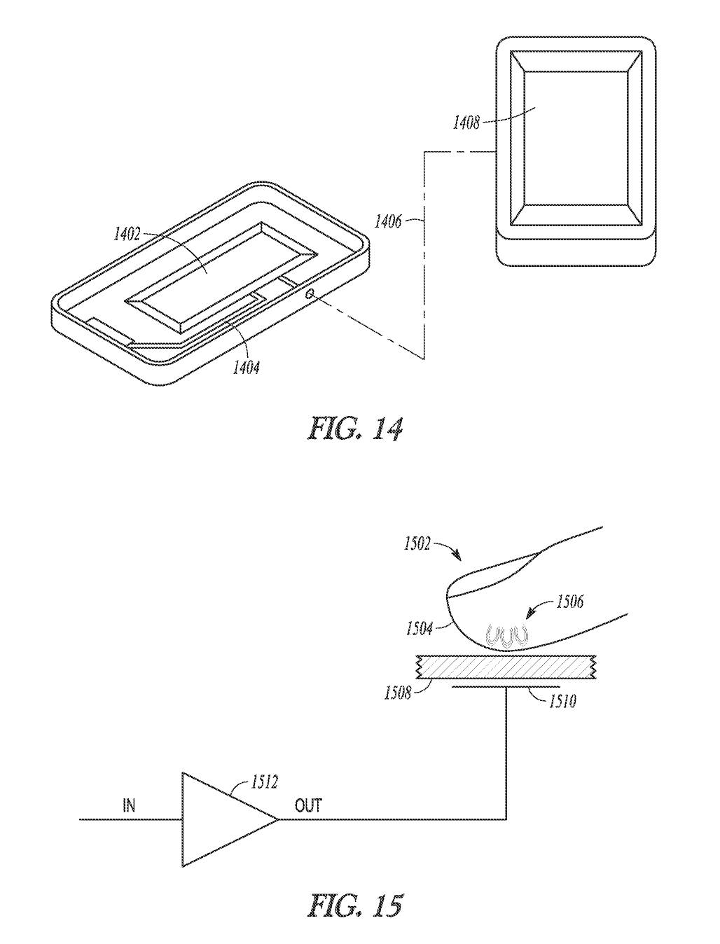

FIG. 14 is a conceptual diagram illustrating two views of the housing 1208 of the haptic cover 1214, according to some example embodiments. As shown in the left side of FIG. 14, the electronics module 1210 may take the example form of a thin electronics module 1402 mounted or otherwise affixed to the interior of the housing 1208. An internal connector 1404 may connect or otherwise communicatively couple the thin electronics module 1402 to the communication interface 1212.

As shown in the right side of FIG. 14, an additional mechanics module 1408 (e.g., a non-transparent pixel implementing Senseg Tixel® technology) may be mounted or otherwise affixed to the exterior of the housing 1208. An additional connector 1406 may connect or otherwise couple (e.g., electrically and communicatively) the mechanics module 1408 and the thin electronics module 1402.

The haptic cover 1214 (e.g., the housing 1208) may be designed and manufactured with any material possible, such as rubber or plastics. According to various example embodiments, the haptic cover 1214 may include the following parts: one or more mechanics modules (e.g., mechanics modules 1204 and 1408), an electronics module (e.g., electronics module 1210, thin electronics module 1402, or other suitably configured electronic circuitry), an internal communication interface (e.g., internal communication interface 1302), an external communication interface (e.g., external communication interface 1306), and a housing (e.g., housing 1208) to which the other parts are mounted, affixed, or otherwise attached.

According to various example embodiments, the electronics module 1210 (e.g., the thin electronics module 1402) includes one or more electronic circuits, a controller (e.g., a microcontroller), and communication electronics. The electronics module 1210 may be configured to control haptic feedback and communication with the host device 1202. The electronics module 1210 may be galvanically connected to the internal communication interface 1302, where the internal communication interface 1302 serves as a medium to connect the host device 1202 to the electronics module 1210. This internal communication interface 1302 may be configured to support communication between devices (e.g., between the host device 1202 and the haptic cover 1214, obtain (e.g., get) power (e.g., from host device 1202), and ground the host device 1202, the haptic cover 1214, or both. If the haptic cover 1214 is built with its own ground and battery, the internal communication interface 1302 may utilize a wireless connection to the host device 1202, and a physical connector may be omitted from the internal communication interface 1302.

The internal communication interface 1302 may further be connected to the external communication interface 1306 to provide communication means between the host device 1202 and one or more external devices, such as a charger. The external communication interface 1306 may also be a serial interface configured to connect with a PC, or it may be used for programming the electronics module 1210 (e.g., with firmware changes). This external communication interface 1306 may be omitted (e.g., where there is no internal physical connector in the haptic cover 1214). The external communication interface 1306 may provide a charging capability to one or more batteries (e.g., battery 1102) within the haptic cover 1214 (e.g., where the haptic cover 1214 is using its own battery for power).

The electronics module 1210 may also be connected to the additional mechanics module 1408 to provide a haptic effect on the backside of the haptic cover 1214. The mechanics module 1408 may include a Senseg Tixel® layer or some other haptics-providing mechanism (e.g., vibration motors or piezoelectric actuators). The mechanics module 1408, as illustrated in FIG. 14, may be located in the center of the haptic cover 1214 or in one or more edges of the haptic cover 1214 (e.g., where the user's hand mostly touches in use).

In the example embodiments shown in FIGS. 12-14, the mechanics module 1204 may be or include a transparent front layer for the haptic cover 1214 (e.g., a Senseg Tixel® surface). Accordingly, the front layer of the haptic cover 1214 cover may enable the user to feel textures and other sensations in front of the host device 1202. Such a transparent front layer (e.g., the mechanics module 1204 in the example form of a transparent tixel layer) may be connected with the electronics module 1210 (e.g., by a connector similar to the connector 1406) in order to provide haptic feedback on the front screen.

According to certain example embodiments, a manufacturer of the host device 1202 may also enable the cover glass of the host device 1202 to include one or more Senseg Tixel® layers. Hence, the front side of the host device 1202 may enable the user to feel textures and other sensations without the need to include a separate screen protector layer on the screen.

According to various example embodiments, the host device 1202 provides input to the haptic cover 1214 via the host-side communication interface 1206 to the communication interface 1212 of the haptic cover 1214, and then the input may be provided to the electronics module 1210 of the haptic cover 1214. This process may also be executed by wireless communication methods. The electronics module 1210 is configured to process (e.g., manipulate) the input and then send a corresponding haptic signal to one or more mechanics modules (e.g., mechanics module 1204, mechanics module 1408, or both), which then gives one or more feelings to one or more body members (e.g. to a hand of the user) touching the host device 1202 through the haptic cover 1214 device.

Furthermore, there may be multiple conductive layers embedded into haptic cover material (e.g., the mechanics module 1204 in the example form of a tixel layer that implements Senseg Tixel® technology). For example, one layer may function as a main effect causing electrode, while another layer may be a ground electrode. This may have the effect of distributing a generated electrostatic field (e.g., causing an attractive electrostatic force between the main effect causing electrode and a body member of the user) evenly throughout the device. Having a grounding electrode and an active electrode in the same mechanical cover (e.g., coated to the different sides of the cover and then being insulated) may provide an advantage in that the largest mechanical forces caused by the Coulomb force may be contained in the haptic cover 1214. Thus, vibrations between the haptic cover 1214 and the host device 1202 may be reduced or eliminated.

FIG. 15 is a conceptual diagram illustrating generation of a capacitive electrical coupling within a capacitive electrical interface (CEI), according to some example embodiments. Subcutaneous vibration-sensitive receptors (e.g., mechanoreceptors, such as Pacinian corpuscles) can be stimulated by means of a capacitive electrical coupling and an appropriately dimensioned control voltage, either without any mechanical stimulation of the mechanoreceptors or as an additional stimulation separate from such mechanical stimulation. An appropriately dimensioned high voltage is used as the control voltage. In the present context a high voltage means a voltage such that direct galvanic contact must be prevented for reasons of safety or user comfort. This results in a capacitive coupling between the mechanoreceptors and the apparatus causing the stimulation, wherein one side of the capacitive coupling is formed by at least one galvanically isolated electrode connected to the stimulating apparatus, while the other side, in close proximity to the electrode, is formed by the body member, preferably a finger, of the stimulation target, such as the user of the apparatus, and more specifically the subcutaneous mechanoreceptors. The capacitive coupling is formed by generating an electric field between an active surface of the apparatus and the body member, such as a finger, approaching or touching it. The electric field tends to give rise to an opposite charge on the proximate finger. A local electric field and a capacitive coupling can be formed between the charges. The electric field directs a force on the charge of the finger tissue. By appropriately altering the electric field a force capable of moving the tissue may arise, whereby the sensory receptors sense such movement as vibration.

FIG. 15 illustrates the operating principle of CEI which can be employed in a touch screen interface, in a haptic companion device (e.g., haptic cover), or any suitable combination thereof. The output of a high-voltage amplifier 1512, denoted OUT, is coupled to an electrode 1510 which is insulated against galvanic contact by an insulator 1508 comprised of at least one insulation layer or member. Reference numeral 1502 generally denotes a body member to be stimulated, such as a human finger. Human skin, which is denoted by reference numeral 1504, is a relatively good insulator when dry, but the CEI provides a relatively good capacitive coupling between the electrode 1510 and the body member 1502. The capacitive coupling is virtually independent from skin conditions, such as moisture. The capacitive coupling between the electrode 1510 and the body member 1502 generates a pulsating Coulomb force. The pulsating Coulomb force stimulates vibration-sensitive receptors (e.g., mechanoreceptors, mainly those called Pacinian corpuscles) which reside under the outermost layer of skin 1504 (e.g., in the hypodermis). The vibration-sensitive receptors are denoted by reference numeral 1506. They are shown schematically and greatly magnified.

The high-voltage amplifier 1512 is driven by an input signal IN which results in a substantial portion of the energy content of the resulting Coulomb forces residing in a frequency range to which the vibration-sensitive receptors 1506 are sensitive. For human users, this frequency range is between 10 Hz and 1000 Hz, preferably between 50 Hz and 500 Hz and optimally between 100 Hz and 300 Hz, such as about 240 Hz.

It should be understood that while “tactile” is frequently defined as relating to a sensation of touch or pressure, the electrosensory interface according to the present CEI, when properly dimensioned, is capable of creating a sensation of vibration to a body member even when the body member 1502 does not actually touch the insulator 1508 overlaying the electrode 1510. This means that unless the electrode 1510, the insulator 1508, or both, are very rigid, the pulsating Coulomb forces between the electrode 1510 and body member 1502 (e.g., the vibration-sensitive receptors 1506) may cause some slight mechanical vibration of the electrode 1510, insulator 1508, or both, but methods and apparatus (e.g., haptic cover 1214) that utilize CEI are capable of producing the electrosensory sensations independently of such mechanical vibration.

The high-voltage amplifier 1512 and the capacitive coupling over the insulator 1508 are dimensioned such that Pacinian corpuscles or other mechanoreceptors are stimulated and an electrosensory sensation (a sensation of apparent vibration) is produced. For this, the high-voltage amplifier 1512 must be capable of generating an output of several hundred volts or even several kilovolts. In practice, the alternating current driven into the body member 1502 has a very small magnitude and can be further reduced by using a low-frequency alternating current.

According to certain example embodiments, a multi-layered tixel structure provides the CEI functionality discussed above. In particular, such a multi-layered tixel structure may include a substrate, a conductive layer (e.g., functioning as an electrode, a conductor, or other charge dissipative layer), an insulative hard coat, and a hydrophobic layer (e.g., to minimize fingerprints and provide ease of cleaning). The insulative hardcode and the hydrophobic layer may be combined into a single layer. When the multi-layered tixel structure overlays the touch screen of the host device, the conductive layer in the multi-layered tixel structure may be charged to the electric potential by the touch screen itself. For example, the touch screen may have its own layer of conductive material (e.g., iridium tin oxide), and the haptic companion device may cause the host device to charge this layer within the touch screen. The may have the effect of charging the conductive layer in the haptic companion device by capacitive means.

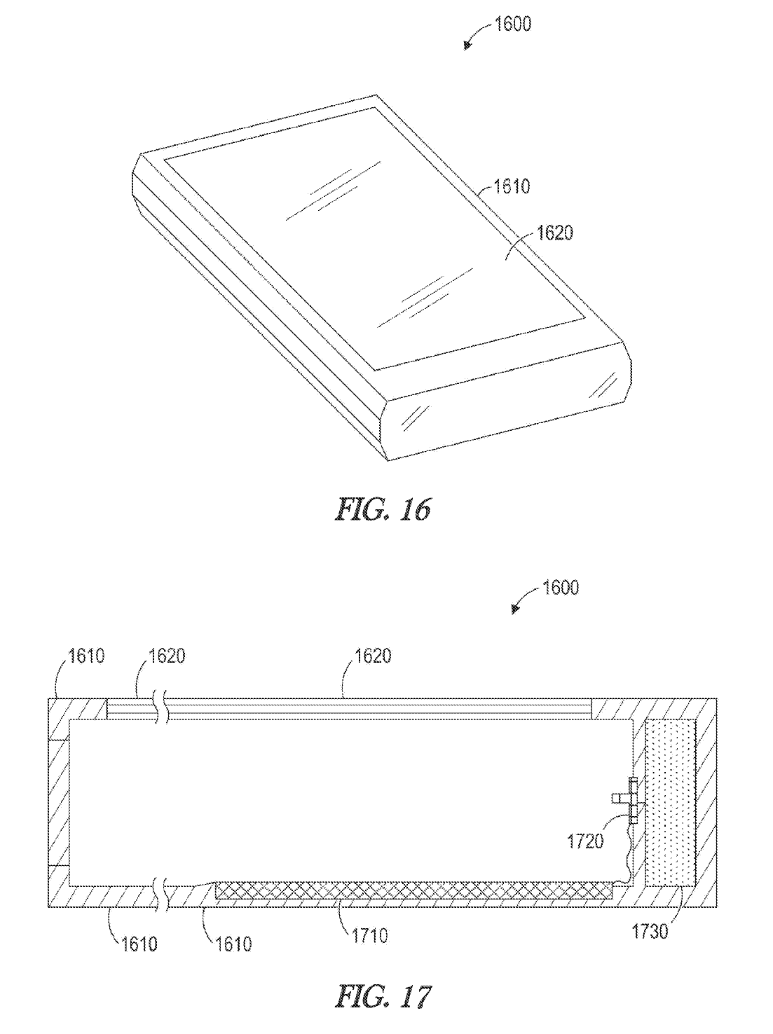

FIG. 16 is a perspective view of a haptic companion device 1600, according to some example embodiments. The haptic companion device 1600 may take the example form of a haptic cover (e.g., haptic cover 1214 or a similar protective case for a host device). As shown in FIG. 16, the haptic device 1600 includes a housing 1610 (e.g., housing 1208) and a transparent component 1620 (e.g., mechanics module 1204, which may be a transparent tixel layer implemented using Senseg Tixel® technology). The housing 1610 may be shaped and dimensioned to receive a host device (e.g., host device 1202). As noted above, the host device may include a touch screen, and such a touch screen may be configured to sense an input by a body member (e.g., a finger or hand) of a user of the host device.

The transparent component 1620 (e.g., a transparent tixel layer) is configured or arranged to overlay the touch screen of the host device when haptic companion device 1600 is in use (e.g., attached to the host device). The transparent component 1620 may include a conductor (e.g., electrode 1510) and an insulator (e.g., insulator 1508) that insulates the conductor from an exposed surface of the transparent component 1620 (e.g., from an exposed surface of the insulator 1508, from the skin 1504 of the body member 1502, or from both).

FIG. 17 is a cross-sectional view of the haptic companion device 1600, illustrating a longitudinal cross-section of the haptic companion device 1600, according to some example embodiments. As shown in FIG. 17, the housing 1610 of the haptic companion device 1600 is configured to receive a host device (e.g., via an opening in the housing 1610 located on the left side of FIG. 17). As noted above, the housing 1610 may be made of rubber, plastic, or any suitable combination thereof. When in use, the transparent component 1620 of the haptic companion device 1600 overlays the touch screen of the host device, and graphical objects displayed on the touch screen of the host device are visible through the transparent component 1620 (e.g., with little or no obstruction or optical filtering). As noted above, the transparent component 1620 may be or include a multi-layer structure that includes multiple conductors (e.g. multiple instances of the conductor 1510) and multiple insulators (e.g., multiple instances of the insulator 1508), which may confer the capability to provide sophisticated haptic effects (e.g., directional haptic effects, rotational haptic effects, or haptic effects of varying area).

Also shown in FIG. 17 is electronic circuitry 1710 (e.g., electronics module 1210) and a communication interface 1720 (e.g., communication interface 1212), which may be communicatively coupled (e.g., connected) to each other (e.g., by the internal connector 1404). The communication interface 1720 may be configured to communicatively couple the haptic companion device 1600 with the host device. The electronic circuitry 1710 may be coupled (e.g., electrically, communicatively, or both) to the transparent component 1620 (e.g., to one or more conductors of the transparent component 1620). Furthermore, the electronic circuitry 1710 may be configured to provide (e.g., cause, initiate, or trigger) a haptic effect to the body member 1502 via the transparent component 1620.

Any one or more of the components (e.g., modules) described herein may be implemented using hardware (e.g., one or more processors of a machine) or a combination of hardware and software. For example, any component described herein may configure a processor (e.g., among one or more processors of a machine) to perform the operations described herein for that component. Moreover, any two or more of these components may be combined into a single component, and the functions described herein for a single component may be subdivided among multiple components.

In some example embodiments, the haptic companion device 1600 includes a battery 1730 (e.g., battery 1102) within the housing 1610. The battery 1730 may be used to provide power to the electronic circuitry 1710, the host device, or both.

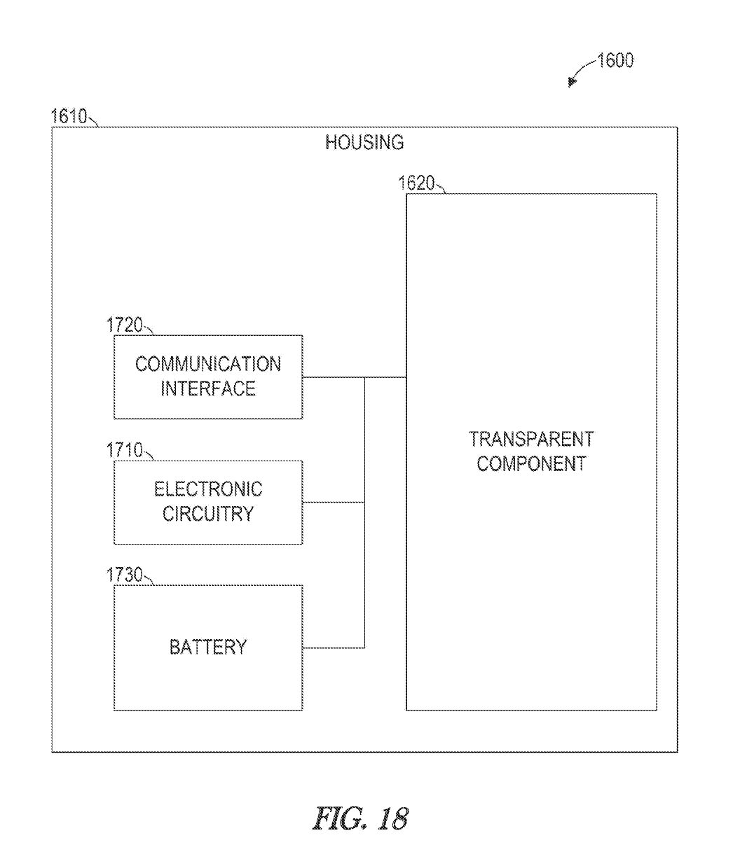

FIG. 18 is a block diagram illustrating components of the haptic companion device 1600, according to some example embodiments. As shown in FIG. 18, the transparent component 1620, the communication interface 1720, the electronic circuitry 1710, and the battery 1730 are included within (e.g., mounted, affixed, or otherwise attached to) the housing 1610. Moreover, the transparent component 1620, the communication interface 1720, and the battery 1730 may be coupled to each other (e.g., electrically, communicatively, or both).

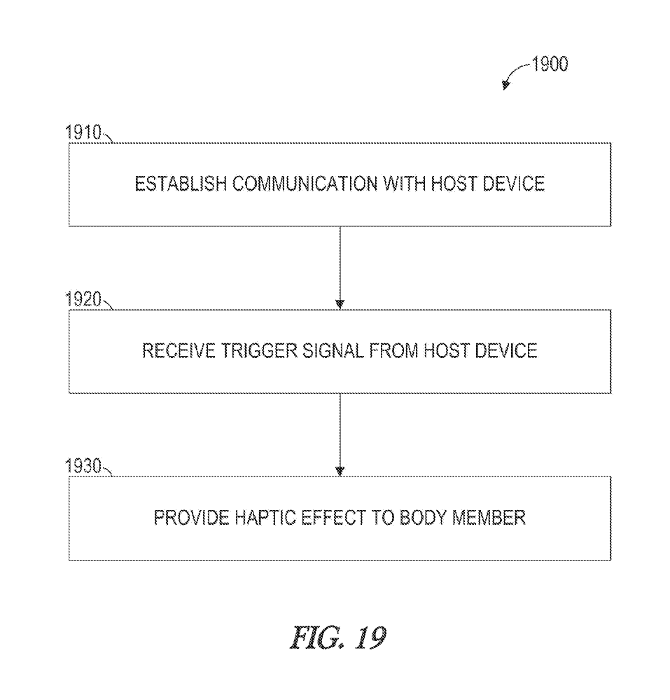

FIG. 19 is a flowchart illustrating operations of the haptic companion device 1600 in performing a method 1900 of providing a haptic effect, according to some example embodiments. As shown in FIG. 19, the method 1900 includes operations 1910, 1920, and 1930.

In operation 1910, the haptic companion device 1600 establishes communication with a host device (e.g., host device 1202) via the communication interface 1720. In particular, the electronic circuitry 1710 may be configured by suitable hardware (e.g., a physical connector), software, or both to establish this communication with the host device.

In operation 1920, a haptic companion device 1600 receives a trigger signal from the host device in response to an input on a touch screen of the host device by a body member (e.g., body member 1502) of the user of the host device. In particular, the communication interface 1720 may be configured to receive the trigger signal from the host device. Moreover, the electronic circuitry 1710 may be configured to detect (e.g., by subsequently receiving) this trigger signal received by the communication interface 1720.

In some example embodiments, the electronic circuitry 1710 is further configured to receive (e.g., from the host device and via the communication interface 1720) position indication that indicates a position on the touch screen where the input sensed by the host device. For example, the input sensed by the host device may be a direct physical contact of the body member with an exposed surface of the transparent component 1620 (e.g., indirectly sensed by the touch screen through the transparent component 1620). In such example embodiments, the electronic circuitry 1710 may be further configured to provide (e.g., cause) the haptic effect at a corresponding position on the transparent component 1620. For example, the corresponding position on the transparent component 1620 may cover (e.g., overlay) the position on the touch screen at which the input is sensed.

In operation 1930, the haptic companion device 1600 provides a haptic effect to the body member (e.g., body member 1502) via the transparent component 1620. In particular, the electronic circuitry 1710 may be configured to provide the haptic effect by causing the haptic effect to be generated or otherwise provided by the transparent component 1620. Moreover, the haptic effect may be provided in response to the trigger signal received in operation 1920. Hence, the receiving of the trigger signal may trigger generation of the haptic effect.

In some example embodiments, as noted above, the haptic effect may be provided by generating an attractive electrostatic force (e.g., a Coulomb force) between the body member (e.g., body member 1502) and a conductor (e.g., electrode 1510) within the transparent component 1620. In such example embodiments, the electronic circuitry 1710 may be configured to provide (e.g., cause) the haptic effect by causing generation of the attractive electrostatic force.

In certain example embodiments, as noted above, the haptic companion device 1600 can draw power from the host device (e.g., host device 1202), supply power to the host device, or both. In particular, the communication interface 1720 may be configured to transfer power between the host device and the battery 1730 of the haptic companion device 1600.

In various example embodiments, as noted above, the housing 1610 (e.g., housing 1208) of the haptic companion device 1620 is configured to provide an additional haptic effect via the housing 1610 (e.g., via the mechanics module 1408, which may be located on the back surface of the housing 1610). In such example embodiments, performance of operation 1930 may include providing one or more additional haptic effects via the housing 1610 (e.g., to a further body member of the user in contact with the housing 1610).

According to some example embodiments, the haptic effect may be selected from a library of haptic effects. In such example embodiments, the electronic circuitry 1710 is further configured to select the haptic effect to be provided in operation 1930. The electronic circuitry 1710 may select the haptic effect from a library of haptic effects, based on the input sensed by the host device (e.g., as indicated by the trigger event received in operation 1920). Such a library of haptic effects may be included in software (e.g., firmware) that configures the electronic circuitry 710 (e.g., firmware within the controller 1106).

According to certain example embodiments, as noted above, the housing 1610 of the haptic companion device 1600 at least partially covers the host device (e.g., host device 1202). Moreover, the input by the body member (e.g., as indicated by the trigger event received in operation 1920) may indicate a press by the body member on a graphical icon that is displayed on the touch screen of the host device. In such example embodiments, the electronic circuitry 1710 may be configured to perform operation 1930 in response to the press on the graphical icon. In particular, the haptic effect provided in operation 1930 may correspond to the graphical icon (e.g., according to store correlations of graphical icons to haptic effects within a library of haptic effects).

For example, the graphical icon may be a virtual key within an on-screen keyboard that is displayed on the touch screen of the host device (e.g., host device 1202), and the electronic circuitry 1710 may respond to the press on the virtual key by providing the haptic effect via the transparent component 1620. As another example, the graphical icon may be a graphical control (e.g., a volume up button) that is operable to increase audio volume (e.g., an audio volume setting) of the host device, and the haptic effect may indicate increasing audio volume by being stronger in intensity than an available alternative haptic effect that indicates a decrease in audio volume. Conversely, the graphical icon may be a graphical control (e.g., a volume down button) that is operable to decrease audio volume of the host device, and the haptic effect may indicate decreasing audio volume by being weaker in intensity than an available alternative haptic effect that indicates an increase in audio volume.

According to various example embodiments, as noted above, the input by the body member (e.g., as indicated by the trigger event received in operation 1920) indicates a swipe (e.g., a drag motion) between two different locations on the touch screen of the host device (e.g., host device 1202). In such example embodiments, the haptic effect may indicate the swipe by being perceivable as a texture (e.g., with a characteristic roughness indicative of a swipe) by the body member (e.g., body member 1502) of the user.

In some example embodiments, as noted above, the input by the body member (e.g., as indicated by the trigger event received in operation 1920) indicates a zoom speed at which content displayed on the touch screen of the host device (e.g., host device 1202) is to be zoomed (e.g., zoomed in or zoomed out) by the host device. In such example embodiments, the haptic effect may indicate the zoom speed by repeating at a rate that corresponds to the zoom speed. For example, the zoom speed may be faster than an available slower zoom speed, and the haptic effect may indicate this zoom speed by having a repetition rate faster than an available alternative repetition rate indicative of the available slower zoom speed. Conversely, the zoom speed may be slower than an available faster zoom speed, and the haptic effect may indicate this zoom speed by having a repetition rate slower than the available faster zoom speed.

In certain example embodiments, as noted above, the input by the body member (e.g., as indicated by the trigger event received in operation 1920) indicates a slide by the body member over a graphical edge of a graphical icon (e.g., a button) displayed on the touch screen of the host device (e.g., host device 1202). In such example embodiments, the haptic effect may indicate the graphical edge of the graphical icon by being perceivable as a physical edge (e.g., a sharp edge) by the body member (e.g., body member 1502) of the user.

According to various example embodiments, one or more of the methodologies described herein may facilitate providing one or more haptic effects to a user. Hence, one or more of the methodologies described herein may obviate a need for certain efforts or resources that otherwise would be involved in providing haptic feedback to a user. Efforts expended by a user in using a touch screen of a host device may be reduced by one or more of the methodologies described herein.

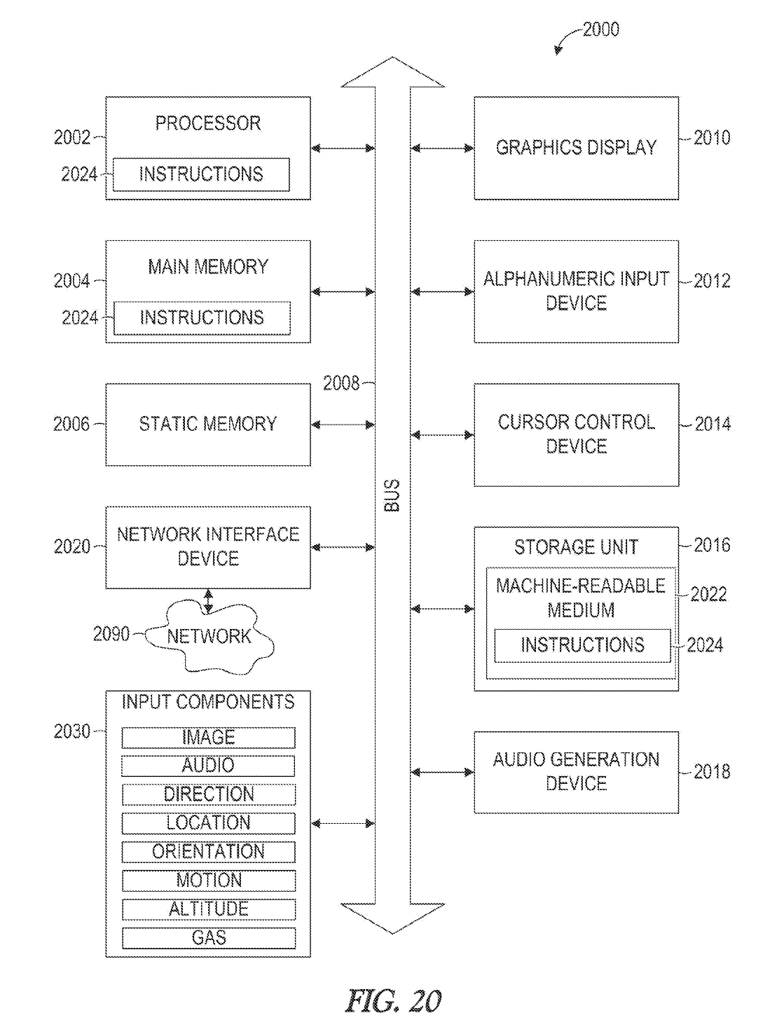

FIG. 20 is a block diagram illustrating components of a machine 2000 (e.g., a haptic companion device 1600, host device 1202, or both), according to some example embodiments, able to read instructions 2024 from a machine-readable medium 2022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 20 shows the machine 2000 in the example form of a computer system (e.g., a computer) within which the instructions 2024 (e.g., software, a program, an application, an applet, an app, or other executable code) for causing the machine 2000 to perform any one or more of the methodologies discussed herein may be executed, in whole or in part.

In alternative embodiments, the machine 2000 operates as a standalone device or may be connected (e.g., networked) to other machines. In a networked deployment, the machine 2000 may operate in the capacity of a server machine or a client machine in a server-client network environment, or as a peer machine in a distributed (e.g., peer-to-peer) network environment. The machine 2000 may be a server computer, a client computer, a PC, a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 2024, sequentially or otherwise, that specify actions to be taken by that machine. Further, while only a single machine is illustrated, the term “machine” shall also be taken to include any collection of machines that individually or jointly execute the instructions 2024 to perform all or part of any one or more of the methodologies discussed herein.

The machine 2000 includes a processor 2002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 2004, and a static memory 2006, which are configured to communicate with each other via a bus 2008. The processor 2002 may contain microcircuits that are configurable, temporarily or permanently, by some or all of the instructions 2024 such that the processor 2002 is configurable to perform any one or more of the methodologies described herein, in whole or in part. For example, a set of one or more microcircuits of the processor 2002 may be configurable to execute one or more modules (e.g., software modules) described herein.

The machine 2000 may further include a graphics display 2010 (e.g., a plasma display panel (PDP), a light emitting diode (LED) display, a liquid crystal display (LCD), a projector, a cathode ray tube (CRT), or any other display capable of displaying graphics or video). The machine 2000 may also include an alphanumeric input device 2012 (e.g., a keyboard or keypad), a cursor control device 2014 (e.g., a mouse, a touchpad, a trackball, a joystick, a motion sensor, an eye tracking device, or other pointing instrument), a storage unit 2016, an audio generation device 2018 (e.g., a sound card, an amplifier, a speaker, a headphone jack, or any suitable combination thereof), and a network interface device 2020.

The storage unit 2016 includes the machine-readable medium 2022 (e.g., a tangible and non-transitory machine-readable storage medium) on which are stored the instructions 2024 embodying any one or more of the methodologies or functions described herein. The instructions 2024 may also reside, completely or at least partially, within the main memory 2004, within the processor 2002 (e.g., within the processor's cache memory), or both, before or during execution thereof by the machine 2000. Accordingly, the main memory 2004 and the processor 2002 may be considered machine-readable media (e.g., tangible and non-transitory machine-readable media). The instructions 2024 may be transmitted or received over a network 2090 (e.g., the Internet) via the network interface device 2020. For example, the network interface device 2020 may communicate the instructions 2024 using any one or more transfer protocols (e.g., HyperText Transfer Protocol (HTTP)).

In some example embodiments, the machine 2000 may be a portable computing device, such as a smart phone or tablet computer, and have one or more additional input components 2030 (e.g., sensors or gauges). Examples of such input components 2030 include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 2022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 2024 for execution by the machine 2000, such that the instructions 2024, when executed by one or more processors of the machine 2000 (e.g., processor 2002), cause the machine 2000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers.” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. An apparatus comprising:
a housing shaped and dimensioned to receive a host device, the host device including a touch screen configured to sense an input by a body member of a user of the host device;
a transparent component that overlays the touch screen in use, the transparent component including a conductor and an insulator that insulates the conductor from an exposed surface of the transparent component;
a communication interface configured communicatively to couple the apparatus with the host device; and
electronic circuitry coupled to the conductor and communicatively coupled to the host device via the communication interface, the electronic circuitry being configured to provide a haptic effect to the body member in response to the input.

2. The apparatus of claim 1, wherein:
the electronic circuitry is configured to receive a trigger signal from the host device via the communication interface in response to the input by the body member of the user, the trigger signal triggering generation of the haptic effect.

3. The apparatus of claim 1, wherein:
the electronic circuitry is configured to receive, from the host device, a position indication that indicates a position on the touch screen where the input is sensed, the electronic circuitry being configured to cause the haptic effect at a corresponding position on the transparent component that overlays the touch screen in use.

4. The apparatus of claim 1, wherein:
the electronic circuitry is configured to provide the haptic effect to the body member by generating an attractive electrostatic force between the body member and the conductor included in the transparent component.

5. The apparatus of claim 1, wherein:
the communication interface is configured to transfer power between the host device and the apparatus.

6. The apparatus of claim 1 further comprising:
a battery configured to provide power to the host device from the apparatus.

7. The apparatus of claim 1, wherein:
graphical objects displayed on the touch screen are visible through the transparent component that overlays the touch screen in use.

8. The apparatus of claim 1, wherein:
the transparent component includes a plurality of conductors that include the conductor and a plurality of insulators that include the insulator.

9. The apparatus of claim 1, wherein:
the electronic circuitry is configured to provide the haptic effect via the transparent component to the body member in contact with the exposed surface of the transparent component.

10. The apparatus of claim 1, wherein:
the electronic circuitry is configured to provide a further haptic effect via the housing of the apparatus to a further body member of the user in contact with the housing.

11. The apparatus of claim 1, wherein:
the communication interface includes a physical connector that communicatively couples the electronic circuitry of the apparatus to the host device.

12. The apparatus of claim 1, wherein:
the communication interface includes a wireless connector that communicatively couples the electronic circuitry of the apparatus to the host device.

13. The apparatus of claim 1, wherein:
the electronic circuitry is configured to select the haptic effect from a library of haptic effects based on the input sensed by the touch screen.

14. The apparatus of claim 1, wherein:
the apparatus is a companion device that, in use, at least partially covers the host device;
the input by the body member indicates a press by the body member on a graphical icon displayed on the touch screen of the host device; and
the electronic circuitry is configured to respond to the press on the graphical icon by providing the haptic effect via the transparent component that overlays the touch screen in use.

15. The apparatus of claim 14, wherein:
the graphical icon is a virtual key within an on-screen keyboard displayed on the touch screen of the host device; and
the electronic circuitry is configured to respond to the press on the virtual key by providing the haptic effect via the transparent component.

16. The apparatus of claim 14, wherein:
the graphical icon is a graphical control operable to increase audio volume of the host device; and
the haptic effect indicates increasing audio volume by being stronger than an available further haptic effect that indicates decreasing audio volume.

17. The apparatus of claim 1, wherein:
the input by the body member indicates a swipe between two locations on the touch screen of the host device; and
the haptic effect indicates the swipe by being perceivable as a texture to the body member.

18. The apparatus of claim 1, wherein:
the input by the body member indicates a zoom speed at which content displayed on the touch screen is to be zoomed by the host device; and
the haptic effect indicates the zoom speed by repeating at a rate that corresponds to the zoom speed.

19. A method of providing a haptic effect in response to an input on a touch screen of a host device by a body member of a user of the host device, the method comprising:
establishing communication with the host device via a communication interface;
receiving a trigger signal from the host device via the communication interface in response to the input on the touch screen of the host device, the trigger signal indicating that the touch screen of the host device sensed the input by the body member of the user, and
providing the haptic effect to the body member via a transparent component that overlays the touch screen in response to the trigger signal, the trigger signal triggering generation of the haptic effect.

20. The method of claim 19, wherein:
the input by the body member indicates a slide by the body member over a graphical edge of a graphical icon displayed on the touch screen; and
the haptic effect indicates the graphical edge of the graphical icon by being perceivable as a physical edge to the body member.
